(19) United States
(12) Patent Application Publication
(10) Pub. No.: US 2004/0010757 A1
(43) Pub. Date: Jan. 15, 2004

(54) Method and system to place a scanned document in the body of an email

(76) Inventors: Craig G. McCoy, Boise, ID (US); Cindy Deng, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/190,587

(22) Filed: Jul. 9, 2002

(51) Int. Cl. G06F 15/00

(52) U.S. Cl. 715/530; 715/531

(57) ABSTRACT

A method, program product, and system is provided for placing a scanned document in an email, the method in one embodiment comprising: obtaining scanned data; and adding the scanned data to a body of an email not as an attached file.

### FIELD OF THE INVENTION

The present invention relates generally to email systems, and more particularly, to the emailing of scanned documents.

### BACKGROUND OF THE INVENTION

Currently, a scanned-in document is converted into a file using a standard image compression algorithm such as for example, JPEG, TIFF, or PDF. The resulting file may then be included as an attachment in an email message to be sent. The receiver of the email message is then required to have an application that can open and view the attached file. Additionally, the receiver of the email must have some familiarity with the mechanics of opening up an attachment in order to view the document therein. This requirement of familiarity of the receiver with opening attachments and the requirement to have the correct application program to open the particular attachment in an email can impede communication with a receiver of a message.

### SUMMARY OF THE INVENTION

In one embodiment of the present invention, a method is provided for placing a scanned document in an email, comprising: obtaining scanned data; and adding the scanned data to a body of an email not as an attached file.

In a further embodiment of the present invention, a program product is disclosed for placing a scanned document in an email, comprising machine readable program code for causing a machine to perform the following method steps: obtaining scanned data; and adding the scanned data to a body of an email not as an attached file.

In yet a further embodiment of the present invention, a system is disclosed for placing a scanned document in an email, comprising: a component for obtaining scanned data; and a component for adding the scanned data to a body of an email not as an attached file.

In yet another further embodiment of the present invention, a system is provided for placing a scanned document in an email, comprising: means for obtaining scanned data; and means for adding the scanned data to a body of an email not as an attached file.

### BRIEF DESCRIPTION OF THE DRAWINGS

FIG. 1 is a schematic block diagram of an embodiment of the present invention.

FIG. 2 is a schematic block diagram of an embodiment of the present invention.

FIG. 3 is a schematic block diagram of a further embodiment of the present invention.

### DETAILED DESCRIPTION OF EMBODIMENTS OF THE INVENTION

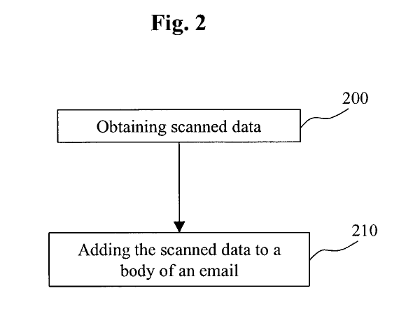

Referring now to FIG. 2, there is shown one embodiment of the invention. In block 200, scanned data is obtained. This scanned data may be obtained by means of a scanning operation or by other convenient means such as communication of the scanned data from a network. One way of implementing block 200 is to utilize a scan-to-email feature of a printer or multi-function printer, such as a Hewlett Packard MFP Model 4100, to obtain the scan data.

Referring now to block 210, the scanned data from block 200 is added to a body of an email. In one example embodiment, this step may be performed by converting the scanned data from a scanned-in document to a markup language. For example, the scanned data could be converted using HTML.

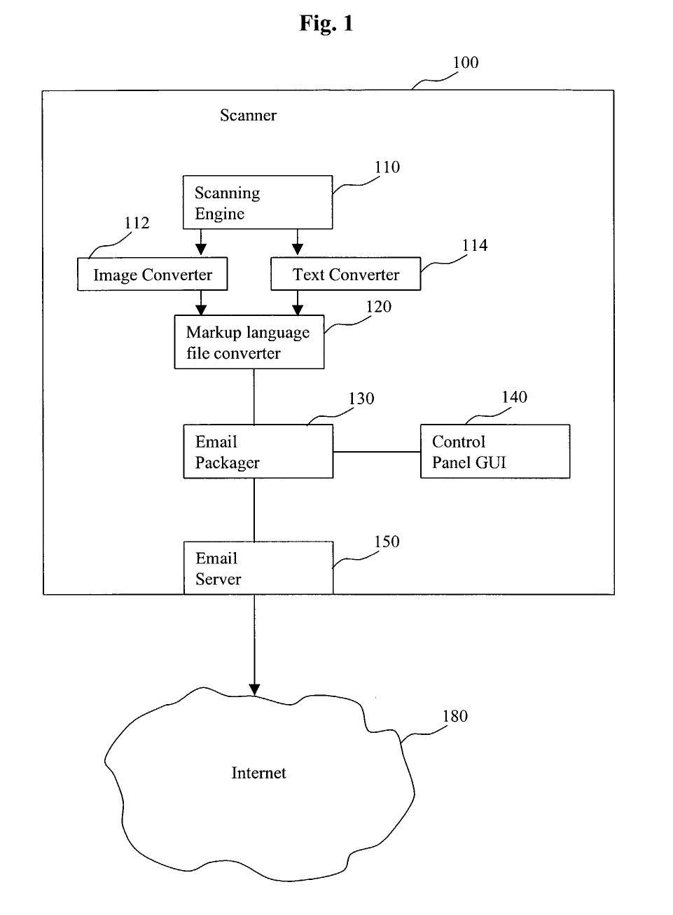

Referring now to FIG. 1, a system for performing the operation of the present invention is shown. In FIG. 1, a scanner 100 is provided which includes a scanning engine 110, one or more file converters for converting to an image, text, or other convenient file format, a markup language file converter 120, an email packager 130, control panel for a GUI 140, and an email server 150.

The scanning engine 110 may be implemented by any convenient current or future scanning engine. The scanner 100 in the example embodiment further includes an image converter 112 and a text converter 114. The image converter may be implemented to convert to a JPEG or GIF or other convenient image file format. The text converter may comprise a current or future optical character recognition device for converting a text file.

Likewise, the markup language file converter 120 could be implemented by any current or future markup language file converter. Likewise, the email packager 130 could be implemented by current or future email packagers.

The embodiment of the scanner 100 also includes a control panel GUI 140 for interfacing with a user. The scanner 100 would also include an email server 150 for serving files to the Internet 180 or other communication medium. The email server 150 may use the SMTP protocol for example to send email through an email gateway.

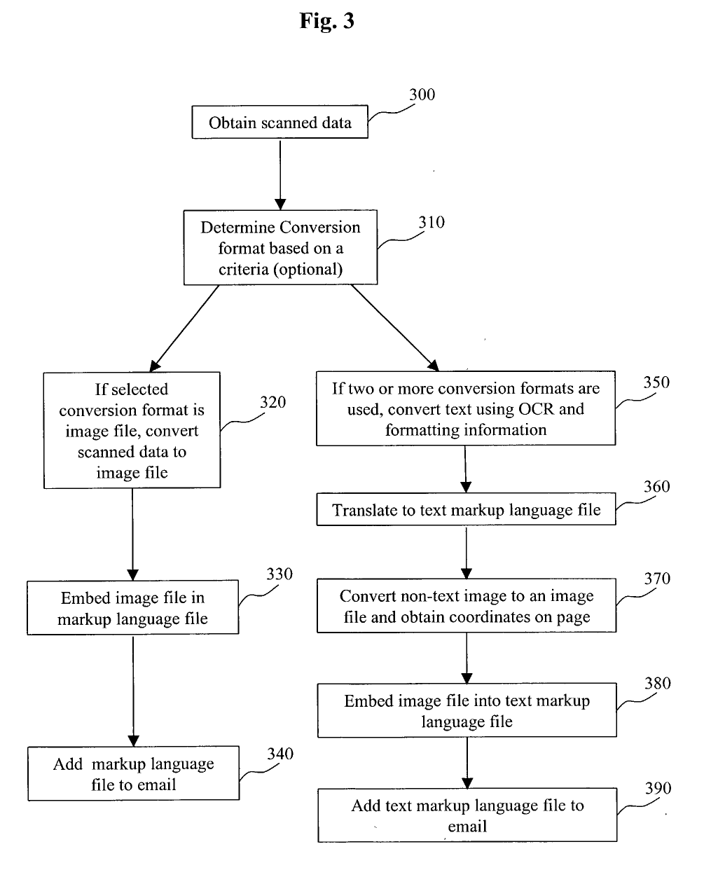

Referring now to FIG. 3, a further embodiment of the present invention is shown. In block 300, scanned data is obtained. As noted previously, this scanned data could be obtained by means of a scanning operation, by means of a download from a network, or by other convenient means. In block 310 a conversion format for the data is determined based on a pre-determined criteria. In one example embodiment of the present invention, this pre-determined criteria might be that a percentage of the scanned data that is text equals or exceeds a pre-determined value. It should be noted that this block 310 is optional. Alternative configurations with this block is deleted will be discussed below.

Referring now to block 320, if the conversion format selected based on the pre-determined criteria is an image file format, then the scanned data is converted to the image file format. Such an image file format conversion operation could, for example, convert to JPEG or GIF format.

In block 330, the image file would be embedded in a markup language file. In block 340, the markup language file would then be added to an email. In one embodiment of the present invention, the text markup language file would be added to the body of the email. A typical method for adding the text markup language file to the body of the email is to place the contents of the file in the body of the email as an ASCII string.

Referring to block 350, if two or more conversion formats are to be used based on the predetermined criteria, then the text in the scanned data would be converted using optical character recognition techniques (OCR), including obtaining appropriate formatting information such as font size, style and color.

In block 360 the converted text would be translated to a text markup language file, such as an HTML file.

In block 370, non-text images are converted to an image file (for example JPEG or GIF) and appropriate coordinates for the location of the image on the page are obtained. The coordinates may be obtained, by way of example bit not by way of limitation, by knowing the position of the scanner—which can be determined electro-mechanically for example (i.e. the position of stepper motors) or by how much data has currently been obtained in the x- and y-coordinates) Note that as an alternative to determining the coordinates for the location of the non-text image, a default location comprising a default set of coordinates could be utilized. For example, a default set of coordinates might place the image at the upper left portion of the page where a company logo might always be located.

Referring to block 380, the image file obtained in block 370 is embedded into the text markup language file generated in block 360.

In block 390, the text markup language file is added to the email. As noted previously, this addition to the email may be implemented by adding a tag indicating the body of the email to the file.

As noted previously, the conversion determining block 310 is optional and could be eliminated. In one such embodiment, the scanned data obtained in block 300 would be sent directly to block 320 and all of the scanned data would be converted to an image file. The resulting image file would then be embedded in a markup language file in block 330. In block 340, the resulting markup language file would be added to the email.

An alternative embodiment where the conversion determining block 310 has been eliminated would be to send the scanned data from block 300 directly to block 350. The scanned data would then be processed in blocks 350-390 as described earlier.

As noted, the tags attached to the various different text markup language files would determine their spatial placement within the email. Likewise, the tags added to the different image markup language files would also determine the placement of those images within the email.

It should be noted that one embodiment of a control panel GUI for block 140 would provide a visual selection control on a graphical user interface for an email method of the present invention to allow selection of the method for sending a scanned document by email. When a user clicks on a button or makes some other convenient indication designating a selection, the email method of the present invention will be invoked.

Accordingly, scanned data obtained from any source, including a scanned-to-email feature of a multi-function printer, could be converted to a markup language file and added directly to a body or other portion of an email. A system embodiment for implementing the present invention could include a text converter, an image converter, a markup language file converter, and an email packager. An email server will typically be included.

Accordingly, the present invention has one or more of the following advantages, it does not require the receiver of an email message to have a particular application program available on the receiver's system in order to open and view the attached files. Likewise, novice users of email do not need to be familiar with the mechanics of opening an attachment and viewing that attachment. Likewise, the body of the email message is more visible within the receiver's mail application. The present invention is particularly advantageous with devices that include a scanner.

The foregoing description of an embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method for placing a scanned document in an email, comprising:
obtaining scanned data; and
adding the scanned data to a body of an email not as an attached file.

2. The method as defined in claim 1, wherein the adding the scanned data to a body of an email step comprises
converting at least a portion of the scanned data to an image file; and
adding the image file to the body of the email.

3. The method as defined in claim 1, wherein the adding scanned data to a body of an email step comprises
converting at least a portion of text in the scanned data using OCR techniques;
translating the converted text to a text markup language file;
converting at least a portion of non-text image to an image file including coordinates for a location of the non-text image within the text markup language file;
embedding the image file of the non-text image into the text markup language; and
adding the text markup language to a body of an email.

4. The method as defined in claim 3, wherein the adding the text markup language file to a body step comprises adding the text markup language file to the body of the email as an ascii string.

5. The method as defined in claim 1, further comprising sending the email.

6. The method as defined in claim 1, further comprising providing a visual selection control on a graphical user interface for an email method to allow selection of the method for sending a scanned document by email.

7. The method as defined in claim 1, further comprising determining a conversion format based on a predetermined criteria.

8. The method as defined in claim 7, wherein the predetermined criteria is a percentage of text in the scanned data that equals or exceeds a predetermined value.

9. The method as defined in claim 7, wherein the conversion format is an image file format only, or multiple formats including a portion of text in the scanned data converted to an OCR file format and a portion of the image data in the scanned data is converted to an image file.

10. A program product for placing a scanned document in an email, comprising machine readable program code for causing a machine to perform the following method steps:
obtaining scanned data; and
adding the scanned data to a body of an email not as an attached file.

11. The program product as defined in claim 10, further comprising code so that the adding the scanned data to a body of an email step
converts at least a portion of the scanned data to an image file; and
adds the image file to the body of the email.

12. The program product as defined in claim 10, further comprising code so that the adding scanned data to a body of an email step
converts at least a portion of text in the scanned data using OCR techniques;
translates the converted text to a text markup language file;
converts at least a portion of non-text image to an image file including coordinates for a location of the non-text image within the text markup language file;
embeds the image file of the non-text image into the text markup language; and
adds the text markup language to a body of an email.

13. The program product as defined in claim 12, further comprising code so that the adding the text markup language file to a body step adds the text markup language file as an ascii string to the email body.

14. The program product as defined in claim 10, further comprising code for sending the email.

15. The program product as defined in claim 10, further comprising code for providing a visual selection control on a graphical user interface for an email method to allow selection of the method for sending a scanned document by email.

16. The program product as defined in claim 10, further comprising code for determining a conversion format based on a predetermined criteria.

17. The program product as defined in claim 16, wherein the predetermined criteria is a percentage of text in the scanned data that equals or exceeds a predetermined value.

18. The program product as defined in claim 16, wherein the conversion format is an image file format only, or multiple formats including a portion of text in the scanned data converted to an OCR file format and a portion of the image data in the scanned data is converted to an image file.

19. A system for placing a scanned document in an email, comprising:
a component for obtaining scanned data; and
a component for adding the scanned data to a body of an email not as an attached file.

20. The system as defined in claim 19, wherein the component for adding the scanned data to a body of an email comprises an image converter for converting at least a portion of the scanned data to an image file; and
a component for adding the image file to the body of the email.

21. The system as defined in claim 19, wherein the component for adding scanned data to a body of an email comprises a text converter for converting at least a portion of text in the scanned data using OCR techniques;
a text markup converter for translating the converted text to a text markup language file;
an image converter for converting at least a portion of non-text image to an image file including coordinates for a location of the non-text image within the text markup language file;
a component for embedding the image file of the non-text image into the text markup language; and
a component for adding the text markup language to a body of an email.

22. The system as defined in claim 21, wherein the component for adding the text markup language file to a body of an email adds the text markup language as an ascii string to the email body.

23. The system as defined in claim 19, further comprising an email packager and an email server.

24. The system as defined in claim 19, further comprising a GUI with a visual selection control to allow selection of the method for sending a scanned document by email.

25. The system as defined in claim 19, further comprising a component for determining a conversion format based on a predetermined criteria.

26. The system as defined in claim 25, wherein the predetermined criteria is a percentage of text in the scanned data that equals or exceeds a predetermined value.

27. The system as defined in claim 25, wherein the conversion format is an image file format only, or multiple formats including a portion of text in the scanned data converted to an OCR file format and a portion of the image data in the scanned data is converted to an image file.

28. A system for placing a scanned document in an email, comprising:
means for obtaining scanned data; and
means for adding the scanned data to a body of an email not as an attached file.

29. The system as defined in claim 28, wherein the means for adding the scanned data to a body of an email step comprises
means for converting at least a portion of the scanned data to an image file; and
means for adding the image file to the body of the email.

30. The system as defined in claim 28, wherein the means for adding scanned data to a body of an email comprises
means for converting at least a portion of text in the scanned data using OCR techniques;
means for translating the converted text to a text markup language file;
means for converting at least a portion of non-text image to an image file including coordinates for a location of the non-text image within the text markup language file;
means for embedding the image file of the non-text image into the text markup language; and
means for adding the text markup language to a body of an email.

31. The system as defined in claim 28, further comprising means for providing a visual selection control on a graphical user interface for an email method to allow selection of the method for sending a scanned document by email.

32. The system as defined in claim 28, further comprising means for determining a conversion format based on a predetermined criteria.

33. The system as defined in claim 32, wherein the predetermined criteria is a percentage of text in the scanned data that equals or exceeds a predetermined value.

34. The system as defined in claim 32, wherein the conversion format is an image file format only, or multiple formats including a portion of text in the scanned data converted to an OCR file format and a portion of the image data in the scanned data is converted to an image file.
